(19) United States
(12) Patent Application Publication
(10) Pub. No.: US 2007/0133807 A1
(43) Pub. Date: Jun. 14, 2007

(54) Tag authentication apparatus and method for radio frequency identification system

(75) Inventors: Hang Rok Lee, Daejeon-city (KR); Do Won Hong, Daejeon-city (KR); Ho Won Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/607,496

(22) Filed: Nov. 30, 2006

(30) Foreign Application Priority Data
Dec. 12, 2005 (KR) 10-2005-0121988
Aug. 1, 2006 (KR) 10-2006-0072645

(51) Int. Cl. H04L 9/00

(52) U.S. Cl. 380/282

(57) ABSTRACT

A radio frequency identification (RFID) tag authentication apparatus and method for accomplishing quick authentication and solving privacy problems using a hash algorithm are provided. An RFID tag includes a memory unit storing a tag's secret information and a group's secret information and a hash chain computation unit encrypting secret information based on a hash algorithm. The tag authentication apparatus includes a DB storing information about RFID tags, which is classified into groups and includes each group's secret information and each tag's secret information; a group's secret information search unit finding a group to which a tag to be authenticated belongs; and a tag's secret information search unit searching tags' secret information included in the found group.

### CROSS-REFERENCE TO RELATED PATENT APPLICATIONS

This application claims the benefit of Korean Patent Application No. 10-2005-0121988, filed on Dec. 12, 2005 and Korean Patent Application No. 10-2006-0072645, filed on Aug. 1, 2006, in the Korean Intellectual Property Office, the disclosures of which are incorporated herein in their entirety by reference.

### BACKGROUND OF THE INVENTION

1. Field of the Invention

The present invention relates to a tag authentication apparatus and method for a radio frequency identification (RFID) system, and more particularly, to a RFID tag authentication apparatus and method for accomplishing quick authentication and solving privacy problems using a hash algorithm.

2. Description of the Related Art

A radio frequency identification (RFID) system is an automatic identification system which reads or records information about an object using a radio frequency without physical contact with the object. The RFID system fundamentally includes a RFID tag, a reader, and a back-end database.

However, the feature that an object is identified without physical contact raises various security problems in terms of safety and privacy. For example, when identifiable information is transmitted from the tag to a reader, an attacker can easily eavesdrop on the content of communication between the tag and the reader. In addition, the attacker can make a tracking attack on a tag position based on the eavesdropped information, which directly leads to the infringement of a user's privacy. Accordingly, many developments and researches for overcoming security problems (particularly, a tag privacy problem) in the RFID system have been performed.

Two representative tag authentication methods have been suggested to overcome the tag privacy problem. One method is disclosed in an essay, entitled “Cryptographic Approach to Privacy Friendly Tags” and introduced by M. Ohkubo, K. Suzuki, and S. Kinoshita at an RFID privacy workshop, and provides a protocol overcoming the tag privacy problem based on a hash chain. This method satisfactorily support the privacy protection on a tag, but the amount of calculation for tag search in a back-end database required for authentication of a tag is the same as the amount of calculation needed to check all tags stored in the back-end database. As a result, a lot of time and resources are consumed for tag authentication, whereby efficiency is decreased.

The other method is disclosed in an essay, entitled “Hash-Based Enhancement of Location Privacy for Radio-Frequency Identification Devices Using Varying Identifiers” and introduced by Dirk Henrici and Paul Muller at the PerSec 2004, and provides a protocol for preventing a location tracking attack by updating a tag's ID at both of a tag and a database based on a hash. In this method, an H(ID) and ID value is stored in the database so that a tag is quickly searched for in the database based on an H(ID) value transmitted by the tag. However, when authentication is not normally completed between the tag and the database, the H(ID) value in the tag is not updated and the tag transmits the same H(ID) value for repeated queries of a reader. As a result, a tag location tracking problem may occur.

### SUMMARY OF THE INVENTION

The present invention provides a tag authentication apparatus and method for protecting tag privacy and reducing the amount of calculation needed to search for a tag's ID stored in a back-end database without degrading existing security functions in a radio frequency identification (RFID) system.

According to an aspect of the present invention, there is provided an RFID tag for an RFID system. The RFID tag includes a memory unit storing a tag's secret information, which is used to authenticate an RFID tag, and a group's secret information, which is used to search for a group including the tag's secret information; and a hash chain computation unit encrypting the group's secret information and the tag's secret information based on a hash algorithm to obtain a conversion value.

According to another aspect of the present invention, there is provided a tag authentication apparatus for an RFID system. The tag authentication apparatus includes a DB storing information about RFID tags, which is classified into groups and includes each group's secret information and each tag's secret information; a group's secret information search unit generating a value by performing a hash chain on each group's secret information stored in the DB using a hash algorithm and comparing the generated value with a received group's secret information conversion value to find a group to which a tag to be authenticated belongs; and a tag's secret information search unit generating a value by performing the hash chain on each tag's secret information included in the group found by the group's secret information search unit and comparing the value with a received tag's secret information conversion value to find secret information of the tag to be authenticated in the DB.

According to still another aspect of the present invention, there is provided a method of processing authentication information in an RFID tag of an RFID system. The method includes obtaining a conversion value by encrypting a tag's secret information, which is used to authenticate an RFID tag, and a group's secret information, which is used to search for a group including the tag's secret information, using a hash chain, which is formed in an RFID tag to perform encryption based on a hash algorithm; and updating the group's secret information and the tag's secret information in memory of the RFID tag.

According to yet another aspect of the present invention, there is provided a tag authentication method for an RFID system. The tag authentication method includes classifying information about RFID tags, which includes each group's secret information and each tag's secret information, into groups and storing the classified information; finding a group to which a tag to be authenticated belongs by generating a value by performing a hash chain on each group's secret information using a hash algorithm and comparing the generated value with a received group's secret information conversion value; and finding secret information of the tag to be authenticated by generating a value by performing the hash chain on each tag's secret information included in the found group and comparing the value with a received tag's secret information conversion value.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the basic structure of a radio frequency identification (RFID) system;

FIG. 2 illustrates an RFID tag in an RFID system, according to an embodiment of the present invention;

FIG. 3 illustrates the basic structure of a hash chain;

FIG. 4 illustrates a tag authentication apparatus for an RFID system according to an embodiment of the present invention;

FIG. 5 illustrates a DB structure in a back-end database;

FIG. 6 illustrates a tag authentication method for an RFID system according to an embodiment of the present invention;

FIG. 7 is a flowchart of the tag authentication method illustrated in FIG. 6;

FIG. 8 is a detailed flowchart of operation S760 illustrated in FIG. 7; and

FIG. 9 is a detailed flowchart of operation S770 illustrated in FIG. 7.

### DETAILED DESCRIPTION OF THE INVENTION

Hereinafter, preferred embodiments of the present invention will be described in detail with reference to the attached drawings.

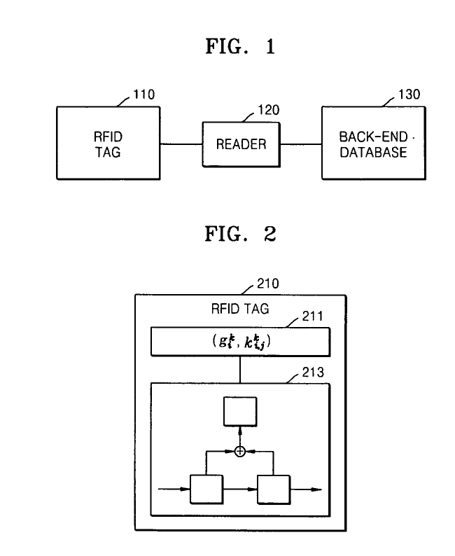

FIG. 1 illustrates the basic structure of a radio frequency identification (RFID) system. Referring to FIG. 1, the RFID system includes an RFID tag 110, a reader 120, and a back-end database 130.

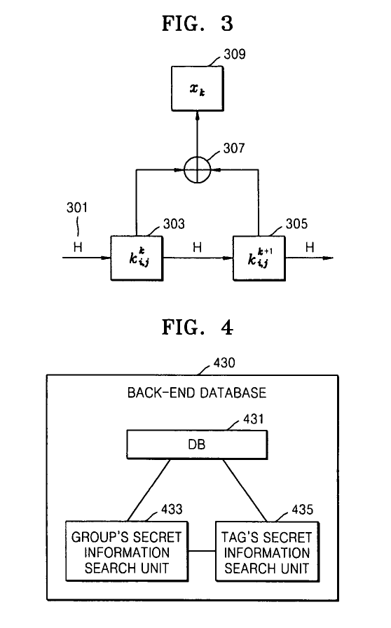

FIG. 2 illustrates an RFID tag 210 in an RFID system, according to an embodiment of the present invention. Referring to FIG. 2, the RFID tag 210 includes a memory unit 211 and a hash chain computation unit 213.

The memory unit 211 stores a tag's secret information, which is used for the authentication of an RFID tag, and a group's secret information, which is used to search for a group including the tag's secret information. An RFID tag must store a group's secret information gᵢ¹ about a secret group, to which the RFID tag belongs, and a tag's secret information kᵢⱼin its initial value.

The group's secret information and the tag's secret information are updated through the iteration of a hash chain in the hash chain computation unit 213 during interaction between the RFID tag 210 and the reader 120 (FIG.1). When there have been m interactions between the RFID tag 210 and the reader 120, a pair of the group's secret information and the tag's secret information stored in the memory unit 211 will be (gᵢ^{m},kᵢⱼ^{m}).

The group's secret information and the tag's secret information in the RFID tag 210 are updated with the same hash chain count at each interaction between the RFID tag 210 and the reader 120 and thus have the same hash chain count.

The hash chain computation unit 213 is formed in the RFID tag 210 based on a hash algorithm. The hash chain computation unit 213 encrypts a group's secret information and a tag's secret information and obtains a conversion value returned to the reader 120. The hash chain computation unit 213 will be described in detail with reference to FIG. 3 later.

The conversion value obtained by the hash chain computation unit 213 is a pair of a group's secret information conversion value yₖ, which is calculated by performing an exclusive OR operation on a value gᵢ^{k} of the group's secret information before hash computation of the group's secret information and a value gᵢ^{k+1} thereof after the hash computation, and a tag's secret information conversion value Xₖ, which is calculated by performing an exclusive OR operation on a value 1ᵢⱼ^{k} of the tag's secret information before hash computation of the tag's secret information and a value kᵢⱼ^{k+1} thereof after the hash computation, i.e., (yₖ,xₖ).

FIG. 3 illustrates the basic structure of a hash chain. Referring to FIG. 3, an exclusive OR operation 307 is performed on a value kᵢⱼ^{k} 303 of a tag's secret information before hash computation is performed on the tag's secret information using a hash algorithm H 301 and a value kᵢⱼ^{k+1} 305 of the tag's secret information obtained after the hash computation. As a result, a tag's secret information conversion value xₖ 309 is obtained. Since an encrypted conversion value is output, security of an RFID tag is guaranteed even if the content of communication between a tag and a reader is eavesdropped on by an attacker. In addition, every time the authentication succeeds, the tag's secret information is updated through the hash chain, whereby a tag privacy problem is overcome.

FIG. 3 illustrates the hash chain for only the tag's secret information, but the same hash chain can be used for the group's secret information using the same hash algorithm. Since only one hash algorithm is needed in a tag authentication method according to the current embodiment, the current embodiment can also be used for a tag having very limited resources.

FIG. 4 illustrates a tag authentication apparatus for an RFID system according to an embodiment of the present invention. A back-end database 430 functioning as an authentication server includes a DB 431, a group's secret information search unit 433, and a tag's secret information search unit 435. Information about all RFID tags to be authenticated is recorded in the back-end database 430. The back-end database 430 searches the DB 431 for an RFID tag corresponding to a conversion value received from a reader and determines whether to authenticate or not.

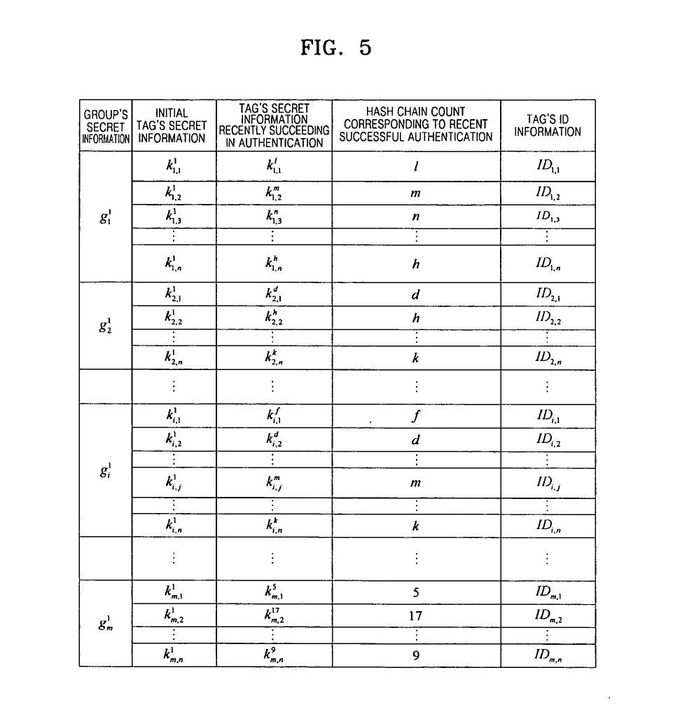

When the information about all RFID tags in the back-end database 430 is checked, a lot of time and system resources are consumed. Accordingly, the information about the RFID tags is divided into groups in the DB 431 for quick and efficient search. The DB structure of the back-end database 430 will be described in detail with reference to FIG. 5 later.

The group's secret information search unit 433 applies a hash chain based on a hash algorithm to all groups'secret information in the DB 431. The operation of the hash chain is repeated until a group's secret information giving a received group's secret information conversion value is found. In other words, a value is obtained through the hash chain of each group's secret information in the DB 431 and is compared with the received group's secret information conversion value until the obtained value is the same as the received group's secret information conversion value. When the group's secret information giving the received group's secret information conversion value is found, the group's secret information search unit 433 transmits the group's secret information to the tag's secret information search unit 435 and an authentication procedure is continued. However, when the group's secret information giving the received group's secret information conversion value is not found in the DB 431, authentication fails. The group's secret information search unit 433 may limit the number of repetitions of the hash chain by setting a threshold to be greater than a greatest hash chain count in a current group.

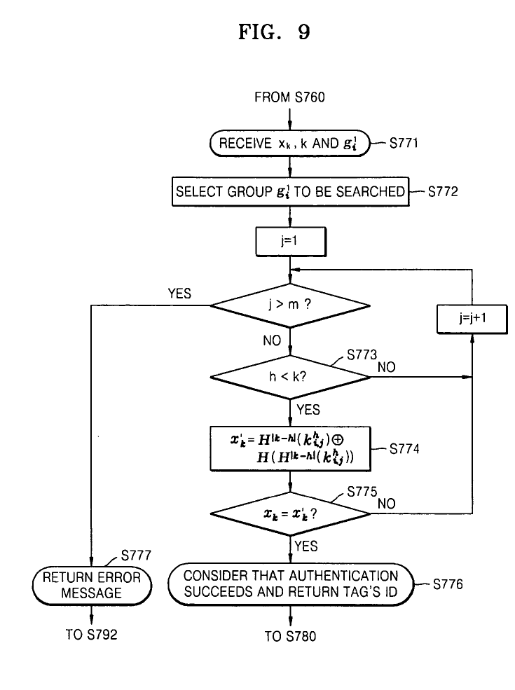

The tag's secret information search unit 435 searches a tag's secret information corresponding to the group's secret information found by the group's secret information search unit 433. Similarly, the hash chain is repeated until a tag's secret information giving a received tag's secret information conversion value is found. The tag's secret information search unit 435 may search only information about RFID tags having a hash chain count less than the hash chain count at which the group's secret information giving the received group's secret information conversion value is found by the group's secret information search unit 433, thereby reducing the amount of hash chain computation. The tag's secret information search unit 435 can reduce the amount of calculation needed for search using a current RFID tag's secret information which succeeds in authentication recently and a hash chain count corresponding to the tag's secret information. This will be described in detail with reference to FIG. 9.

FIG. 5 illustrates a DB structure in a back-end database according to an embodiment of the present invention. Referring to FIG. 5, tags are classified into many groups according to each group's secret information gᵢ¹. In the DB structure, each row refers to a different tag's information. In addition, in the back-end database, information about each RFID tag classified into a group may be stored in a corresponding group in a form of a combination of a tag's initial secret information, kᵢⱼ¹, the tag's secret information recently succeeding in authentication, kᵢⱼ^{m}, a hash chain count m corresponding to the recent successful authentication, and the tag's ID information, IDᵢⱼ, i.e., the combination (kᵢⱼ¹,kᵢⱼ^{m},m,IDᵢⱼ).

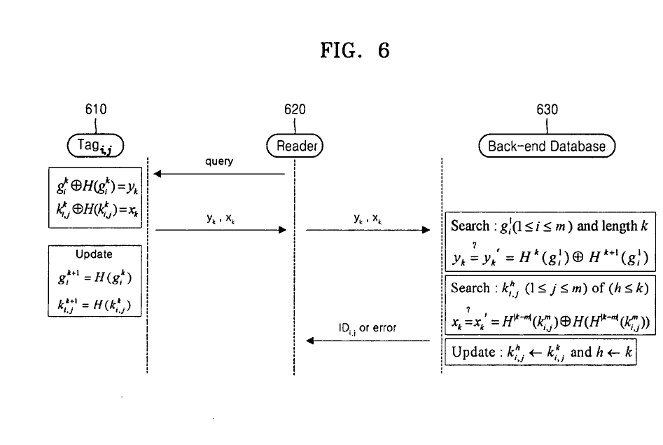

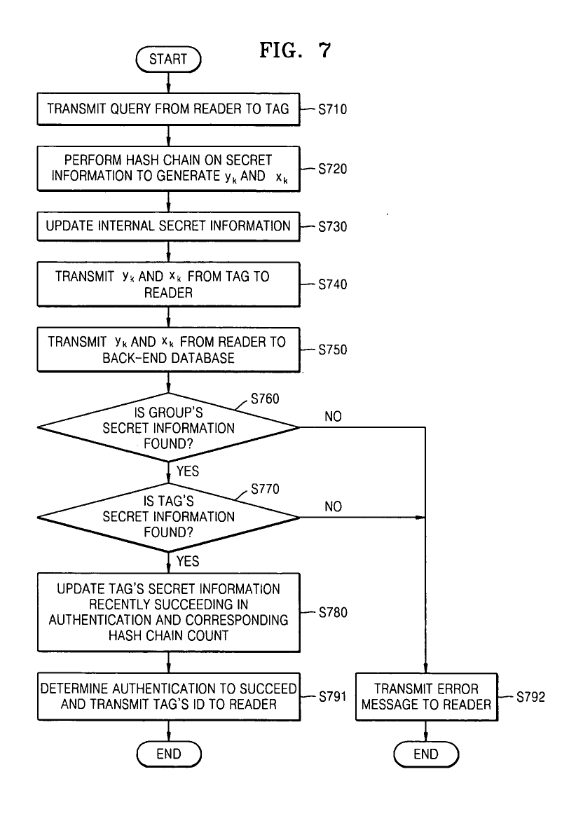

FIG. 6 illustrates a tag authentication method for an RFID system according to an embodiment of the present invention. FIG. 7 is a flowchart of the tag authentication method illustrated in FIG. 6. Referring to FIGS. 6 and 7, a method of processing authentication information performed by an RFID tag 610 of an RFID system according to the current embodiment includes the operations of obtaining a conversion value for a hash chain and updating a group's secret information and a tag's secret information.

In operation S710, a reader 620 transmits a start query to the RFID tag 610. When the current query transmitted to the RFID tag 610 is k-th interaction between the reader 620 and the RFID tag 610, the RFID tag 610 calculates Equation (1) using a group's secret information gᵢ^{k} in operation S720 and updates the group's secret information gᵢ^{k} using Equation (2) in operation S730.
gᵢ^{k}⊕H(gᵢ^{k})=yₖ (1)
gᵢ^{k}←gᵢ^{k+1}=H(gᵢ^{k}) (2)

In the same manner, the RFID tag 610 calculates Equation (3) using a tag's secret information kᵢⱼ^{k} in operation S720 and updates the tag's secret information kᵢⱼ^{k} using Equation (4) in operation S730.
kᵢⱼ^{k}⊕H(kᵢⱼ^{k})=xₖ (3)
kᵢⱼ^{k}←kᵢⱼ^{k+1}=H(kᵢⱼ^{k}) (4)

The RFID tag 610 transmits a group's secret information conversion value yₖand a tag's secret information conversion value xₖ, which are obtained through the above calculations, to the reader 620 in operation S740. The reader 620 transmits the values yₖ and xₖ to a back-end database 630 in operation S750.

The tag authentication method performed by the back-end database 630 of the RFID system according to the current embodiment includes the operations of classifying information into groups, searching for a group's secret information, and searching for a tag's secret information.

As described above, information about all RFID tags to be authenticated is classified into groups in a DB of the back-end database 630. The back-end database 630 searches for a group's secret information based on the values yₖ and xₖ received from the reader 620 in operation S760 and then searches for a tag's secret information using the values yₖ and xₖ in operation S770.

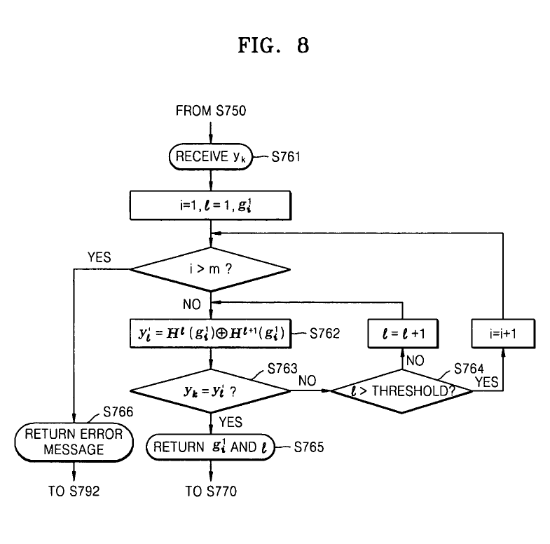

In operation S760, the back-end database 630 performs a hash chain of each group's secret information stored in the DB to find a group's secret information giving the group's secret information conversion value yₖ. When the group's secret information giving the group's secret information conversion value yₖ is found, the found group is selected for the next search. In operation S770, the back-end database 630 performs the hash chain of each tag's secret information included in the selected group to find a tag's secret information giving the tag's secret information conversion value xₖ. Operations S760 and S770 will be described in detail with respect to FIGS. 8 and 9, respectively.

When the back-end database 630 finds a row including the tag's secret information about a tag giving the value xₖ, the back-end database 630 updates the tag's secret information recently succeeding in authentication , kᵢⱼ^{m}, with kᵢⱼ^{k} and updates the hash chain count m corresponding to the recent successful authentication with k on the found row in operation S780. Thereafter, the back-end database 630 considers the RFID tag 610 as authenticated and transmits the tag's ID information on the row to the reader 620 in operation S791.

When the back-end database 630 fails in searching for a group's secret information or fails in searching for a tag's secret information giving the value xₖ in all tags included in the found group gᵢ¹, the back-end database 630 determines that authentication fails and transmits an error message to the reader 110 in operation S792.

In the tag authentication method according to the current embodiment, the group's secret information and the tag's secret information may be updated through the iteration of the hash chain when the RFID tag 610 interacts with the reader 620. In addition, the group's secret information and the tag's secret information may have the same hash chain count. Here, a conversion value obtained through the hash chain may be a pair of a group's secret information conversion value, which is obtained by performing an exclusive OR operation on a value of the group's secret information before a hash chain and a value thereof after the hash chain, and a tag's secret information conversion value, which is obtained by performing an exclusive OR operation on a value of the tag's secret information before a hash chain and a value thereof after the hash chain.

As described above, information about RFID tags may be classified into groups in advance in the back-end database 630, which searches for an RFID tag corresponding to a conversion value received from the reader 620. In addition, each classified group may include a combination of a tag's initial secret information, the tag's secret information recently succeeding in authentication, a hash chain count corresponding to the recent successful authentication, and the tag's ID information.

FIG. 8 is a detailed flowchart of operation S760 illustrated in FIG. 7. Referring to FIG. 8, the back-end database 630 receives the group's secret information conversion value yₖ from the reader 620 in operation S761. The back-end database 630 calculates y′ₖ using Equation (5) to find gᵢ¹ giving yₖ in all groups'secret information gᵢ¹(1≦i≦m) stored in its DB in operation S762 and checks whether y′ₖ is equal to yₖ in operation S763.
y′ₖ=H^{k}(gᵢ¹)⊕H^{k+1}(gᵢ¹) (5)

At this time, the same hash chain as that performed by the RFID tag 610 is performed by the back-end database 630 to check all of the groups stored in the DB.

Alternatively, a threshold may be set for the number of iterations of the hash chain in operation S764 so that the hash chain is iterated within the threshold. The threshold is set to be greater than a greatest hash chain count in a current group. The threshold may vary with the flexibility of the system.

When the group's secret information is found in the DB, the back-end database 630 returns the group's secret information and a current hash chain count to subsequent operation in operation S765.

When the group's secret information is not found in the DB, the back-end database 630 determines that the authentication fails and transmits the error message to the reader 620 in operation S766.

FIG. 9 is a detailed flowchart of operation S770 illustrated in FIG. 7. Referring to FIG. 9, the tag's secret information conversion value xₖ received from the reader 620, a particular group corresponding to the group's secret information gᵢ¹ found in operation S760, and a hash chain count k at which gᵢ¹ is equal to gᵢ^{k} are input in operation S771. The particular group is selected in operation S772. Here, it is important that the group's secret information gᵢ^{k} and the tag's secret information kᵢⱼ^{k} in the RFID tag 610 are updated with the same number of iterations of the hash chain each time when the RFID tag 610 interacts with the reader 620. Accordingly, in a column of the “hash chain count corresponding to the recent successful authentication” included in the group gᵢ¹ in the DB structure, rows storing a hash chain count less than the input hash chain count k are selected and the tag's secret information giving the tag's secret information conversion value xₖ is searched for in the selected rows in operation S773.

In searching for the tag's secret information giving the tag's secret information conversion value xₖ, the hash chain can be computed using a tag's secret information recently succeeding in authentication and a hash chain count corresponding to the recent successful authentication. In other words, the DB in the back-end database 630 stores secret information kᵢⱼ^{m} updated recently when a corresponding tag is successfully authenticated and a hash chain count m corresponding to the recent successful authentication. Accordingly, instead of performing the hash chain k times using kᵢⱼ¹, the hash chain is performed |k−m|times using kᵢⱼ^{m} stored in the DB, as illustrated in Equation (6), so that x′ₖ is quickly obtained in operation S774.
x′ₖ=H^{|k-m|}(kᵢⱼ^{m})⊕H(H^{|k-m|}(kᵢⱼ^{m})) (6)

It is checked whether x′ₖ is equal to the tag's secret information conversion value xₖ received from the reader 620 in operation S775.

When a tag's secret information giving the tag's secret information conversion value xₖ is found in the selected group, the back-end database 630 considers that the authentication succeeds and returns the corresponding tag's ID in operation S776. When a tag's secret information giving the tag's secret information conversion value xₖ is not found in the selected group, the back-end database 630 considers that the authentication fails and transmits the error message to the reader 620 in operation S777.

The invention can also be embodied as computer readable codes on a computer readable recording tag. The computer readable recording tag is any data storage device that can store data which can be thereafter read by a computer system. Examples of the computer readable recording tag include read-only memory (ROM), random-access memory (RAM), CD-ROMs, magnetic tapes, floppy disks, optical data storage devices, and carrier waves (such as data transmission through the Internet). The computer readable recording tag can also be distributed over network coupled computer systems so that the computer readable code is stored and executed in a distributed fashion.

According to the present invention, tag privacy essential to security services in an RFID system environment is protected and the amount of computation necessary to search for a tag's ID stored in a back-end database is remarkably reduced without deteriorating the conventional security features. Accordingly, an RFID tag can be quickly and efficiently authenticated and an appropriate authentication system can be constructed for a huge capacity of an RFID system. Moreover, since an RFID tag can be implemented using only a single hash algorithm, system resources can be efficiently used. Therefore, the present invention can be used for an RFID tag having extremely limited resources.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A radio frequency identification (RFID) tag for an RFID system, the RFID tag comprising:
a memory unit storing a tag's secret information, which is used to authenticate an RFID tag, and a group's secret information, which is used to search for a group including the tag's secret information; and
a hash chain computation unit encrypting the group's secret information and the tag's secret information based on a hash algorithm to obtain a conversion value.

2. The RFID tag of claim 1, wherein the group's secret information and the tag's secret information are updated by iteration of a hash chain when the RFID tag interacts with a reader that receives the conversion value.

3. The RFID tag of claim 1, wherein the group's secret information and the tag's secret information have a same hash chain count.

4. The RFID tag of claim 1, wherein the conversion value is a pair of a group's secret information conversion value, which is obtained by performing an exclusive OR operation on a value of the group's secret information before hash computation of the group's secret information and a value of the group's secret information after the hash computation, and a tag's secret information conversion value, which is obtained by performing an exclusive OR operation on a value of the tag's secret information before hash computation of the tag's secret information and a value of the tag's secret information after the hash computation.

5. A tag authentication apparatus for a radio frequency identification (RFID) system, the tag authentication apparatus comprising:
a DB storing information about RFID tags, which is classified into groups and includes each group's secret information and each tag's secret information;
a group's secret information search unit generating a value by performing a hash chain on each group's secret information stored in the DB using a hash algorithm and comparing the generated value with a received group's secret information conversion value to find a group to which a tag needing authentication belongs; and
a tag's secret information search unit generating a value by performing the hash chain on each tag's secret information included in the group found by the group's secret information search unit and comparing the value with a received tag's secret information conversion value to find secret information of the tag, which needs authentication, in the DB.

6. The tag authentication apparatus of claim 5, wherein the classified information about each RFID tag is stored in a corresponding group in a form of a combination of a tag's initial secret information, the tag's secret information recently succeeding in authentication, a hash chain count corresponding to the recent successful authentication, and a tag's ID information.

7. The tag authentication apparatus of claim 5, wherein the group's secret information search unit limits the number of iterations of the hash chain by setting a threshold to be greater than a greatest hash chain count in a current group.

8. The tag authentication apparatus of claim 5, wherein the tag's secret information search unit searches only information about RFID tags having a less hash chain count than a hash chain count at which the group's secret information search unit finds the group to which the tag to be authenticated belongs.

9. The tag authentication apparatus of claim 5, wherein the tag's secret information search unit performs search using each tag's secret information recently succeeding in authentication and a hash chain count corresponding to the recent successful authentication.

10. A method of processing authentication information in a radio frequency identification (RFID) of an RFID system, the method comprising:
obtaining a conversion value by encrypting a tag's secret information, which is used to authenticate an RFID tag, and a group's secret information, which is used to search for a group including the tag's secret information, using a hash chain, which is formed in the RFID tag to perform encryption based on a hash algorithm; and
updating the group's secret information and the tag's secret information in memory of the RFID tag.

11. The method of claim 10, wherein the group's secret information and the tag's secret information are updated by iteration of the hash chain when the RFID tag interacts with a reader that receives the conversion value.

12. The method of claim 10, wherein the group's secret information and the tag's secret information have a same hash chain count.

13. The method of claim 10, wherein the conversion value is a pair of a group's secret information conversion value, which is obtained by performing an exclusive OR operation on a value of the group's secret information before hash computation of the group's secret information and a value of the group's secret information after the hash computation, and a tag's secret information conversion value, which is obtained by performing an exclusive OR operation on a value of the tag's secret information before hash computation of the tag's secret information and a value of the tag's secret information after the hash computation.

14. A tag authentication method for a radio frequency identification (RFID) system, the tag authentication method comprising:
classifying information about RFID tags, which includes each group's secret information and each tag's secret information, into groups and storing the classified information;
finding a group, to which a tag needing authentication belongs, by generating a value by performing a hash chain on each group's secret information using a hash algorithm and comparing the generated value with a received group's secret information conversion value; and
finding a tag's secret information, needing authentication by generating a value by performing the hash chain on each tag's secret information included in the found group and comparing the value with a received tag's secret information conversion value.

15. The tag authentication method of claim 14, wherein the classified information about each RFID tag is stored in a corresponding group in a form of a combination of a tag's initial secret information, the tag's secret information recently succeeding in authentication, a hash chain count corresponding to the recent successful authentication, and a tag's ID information.

16. The tag authentication method of claim 14, wherein the finding of the group's secret information comprises limiting the number of iterations of the hash chain by setting a threshold to be greater than a greatest hash chain count in a current group.

17. The tag authentication method of claim 14, wherein the finding of the tag's secret information comprises searching only information about RFID tags having a less hash chain count than a hash chain count at which the group to which the tag to be authenticated belongs has been found.

18. The tag authentication method of claim 14, wherein the finding of the tag's secret information comprises perform the hash chain using each tag's secret information recently succeeding in authentication and a hash chain count corresponding to the recent successful authentication.

19. A computer readable recording tag for recording a program for executing the method of any one of claims 10 through 18.
